(19) United States
(12) Patent Application Publication
(10) Pub. No.: US 2020/0133603 A1
(43) Pub. Date: Apr. 30, 2020

(54) IMAGE FORMING SYSTEM, CONTROL DEVICE, AND IMAGE FORMING APPARATUS

(71) Applicant: KONICA MINOLTA, INC., Tokyo (JP)

(72) Inventor: Teppei NAKAMURA, Toyokawa-shi (JP)

(73) Assignee: KONICA MINOLTA, INC., Tokyo (JP)

(21) Appl. No.: 16/663,765

(22) Filed: Oct. 25, 2019

(30) Foreign Application Priority Data
Oct. 31, 2018 (JP) 2018-205192

(51) Int. Cl. G06F 3/12; G06F 3/16

(52) U.S. Cl. CPC G06F 3/1265; G06F 3/167; G06F 3/1204

(57) ABSTRACT

An image forming system includes a control device and a plurality of image forming apparatuses. Each of the plurality of image forming apparatuses includes a first processor and a first memory that accumulates a job. The control device includes a second processor. The second processor obtains information on jobs accumulated in the plurality of image forming apparatuses, receives an instruction from the interactive electronic device, extracts, when there are a plurality of candidates for the job corresponding to the received instruction from the user, a feature of each of the plurality of candidates for the job based on the obtained information on the jobs, generates a question for identifying the job corresponding to the instruction from among the plurality of candidates for the job based on a difference in extracted feature, and transmits the generated question to the interactive electronic device.

The entire disclosure of Japanese Patent Application No. 2018-205192 filed on Oct. 31, 2018 is incorporated herein by reference in its entirety.

### BACKGROUND

### Technological Field

The present disclosure relates to an image forming system, a control device, and an image forming apparatus.

### Description of the Related Art

A system that recognizes speech of a user and performs processing based on the recognized speech has conventionally been known. For example, Japanese Laid-Open Patent Publication No. 2006-88503 describes a technique allowing also a visually impaired user to readily perform printing (see [Abstract]).

Japanese Laid-Open Patent Publication No. 2008-271047 describes a technique allowing identification of a user and an operation of equipment in accordance with the user by a single speech input (see [Abstract]). Japanese Laid-Open Patent Publication No. 2004-61651 describes a technique allowing a visually impaired person to smoothly make copies without confusion (see [Abstract]).

### SUMMARY

According to the technique described in Japanese Laid-Open Patent Publication No. 2006-88503, however, a job attribute of a print job accumulated in an auxiliary spool is read one by one and it takes time to identify a job to be executed. According to the technique described in Japanese Laid-Open Patent Publication No. 2008-271047 or 2004-61651, a user's job identified by a voiceprint is executed, however, the technique has not taken into account identification of a job to be executed from among a plurality of jobs when there are a plurality of user's jobs identified by the voiceprint.

An object in one aspect of the present disclosure is to identify, in a time period as short as possible, to which job a spoken instruction from a user is directed.

To achieve at least one of the abovementioned objects, according to an aspect of the present invention, an image forming system reflecting one aspect of the present invention comprises a control device that communicates with an interactive electronic device that accepts a spoken instruction and a plurality of image forming apparatuses that communicate with the control device. Each of the plurality of image forming apparatuses includes a first processor and a first memory that accumulates a job. The control device includes a second processor. The second processor obtains information on jobs accumulated in the plurality of image forming apparatuses, receives, when the interactive electronic device accepts an instruction from a user for a job accumulated in any of the plurality of image forming apparatuses, the instruction from the interactive electronic device, extracts, when there are a plurality of candidates for the job corresponding to the received instruction from the user, a feature of each of the plurality of candidates for the job based on the obtained information on the jobs, generates a question for identifying the job corresponding to the instruction from among the plurality of candidates for the job based on a difference in extracted feature, and transmits the generated question to the interactive electronic device.

To achieve at least one of the abovementioned objects, according to another aspect of the present invention, a control device reflecting another aspect of the present invention comprises an interface that communicates with an interactive electronic device that accepts a spoken instruction and with a plurality of image forming apparatuses and a processor. The processor obtains information on jobs accumulated in the plurality of image forming apparatuses, receives, when the interactive electronic device accepts an instruction from a user for a job accumulated in any of the plurality of image forming apparatuses, the instruction from the interactive electronic device, extracts, when there are a plurality of candidates for the job corresponding to the received instruction from the user, a feature of each of the plurality of candidates for the job based on the obtained information on the jobs, generates a question for identifying the job corresponding to the instruction from among the plurality of candidates for the job based on a difference in extracted feature, and transmits the generated question to the interactive electronic device.

To achieve at least one of the abovementioned objects, according to another aspect of the present invention, an image forming apparatus reflecting another aspect of the present invention comprises a first processor, a first memory that accumulates a job, and an interface that communicates with a control device that communicates with an interactive electronic device that accepts a spoken instruction. The control device includes a second processor. The second processor obtains information on jobs accumulated in a plurality of image forming apparatuses, receives from the interactive electronic device, an instruction from a user for a job accumulated in any of the plurality of image forming apparatuses, generates, when there are a plurality of candidates for the job corresponding to the instruction, a question for identifying the job corresponding to the instruction based on a difference in feature extracted from each of the plurality of candidates for the job based on the obtained information on the jobs, and transmits the question to the interactive electronic device. The first processor transmits to the control device, the information on the jobs accumulated in the first memory for the control device to extract the feature.

To achieve at least one of the abovementioned objects, according to another aspect of the present invention, an image forming apparatus reflecting another aspect of the present invention comprises a first processor and a first memory that accumulates a job. The first processor accepts a spoken instruction from a user for the job accumulated in the first memory, extracts, when a plurality of candidates for the job corresponding to the instruction are accumulated, a feature of each of the plurality of candidates for the job, generates a question for identifying the job corresponding to the instruction from among the plurality of candidates for the job based on a difference in extracted feature, outputs the generated question, identifies the job corresponding to the instruction based on an answer from the user to the question, and performs processing corresponding to the instruction onto the identified job.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing an image forming system according to an embodiment.

FIG. 2 is a perspective view of an image forming apparatus according to the embodiment.

FIG. 3 is a block diagram showing a hardware configuration of the image forming apparatus.

FIG. 4 is a block diagram showing a hardware configuration ofa smart speaker.

FIG. 5 is a block diagram showing a hardware configuration of a server.

FIG. 6 is a flowchart showing processing by the server.

FIGS. 7 and 8 show tables summarizing features of each of candidates for a job corresponding to an instruction from a user.

FIG. 9 is a flowchart showing processing for a control unit to generate a question.

FIGS. 10 and 11 are sequence diagrams showing exemplary processing by the image forming system.

FIG. 12 is a sequence diagram showing exemplary processing by an image forming apparatus in a modification.

FIG. 13 shows a table summarizing features of each of candidates for a job corresponding to an instruction from a user.

### DETAILED DESCRIPTION OF EMBODIMENTS

Hereinafter, one or more embodiments of the present invention will be described with reference to the drawings. However, the scope of the invention is not limited to the disclosed embodiments.

Each embodiment will be described below in detail with reference to the drawings. The same or corresponding elements in the drawings have the same reference characters allotted and description thereof will not be repeated.

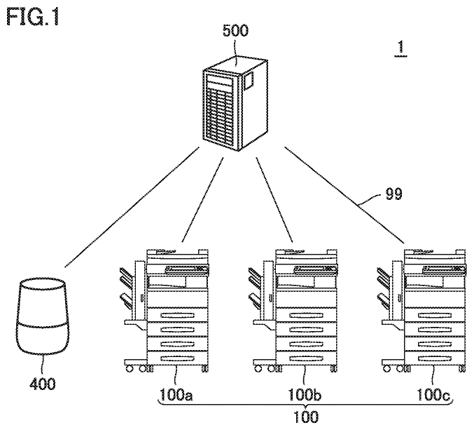

FIG. 1 is a diagram showing an image forming system 1 according to an embodiment. Image forming system 1 includes image forming apparatuses 100a, 100b, and 100c, a smart speaker 400, and a server 500. Image forming apparatuses 100a, 100b, and 100c (which are collectively referred to as an image forming apparatus 100 below) represent exemplary image forming apparatuses. Smart speaker 400 represents an exemplary interactive electronic device and server 500 represents an exemplary control device. Each of image forming apparatuses 100, smart speaker 400, and server 500 are connected to one another through a network 99 and communicate with one another.

Network 99 is implemented by the Internet such as a local area network (LAN) or a wide area network (WAN). Network 99 connects various types of equipment based on a protocol such as transmission control protocol/Internet protocol (TCP/IP). Equipment connected to network 99 can exchange various types of data. Image forming system 1 may include equipment connected to network 99 other than those described above. The image forming apparatus connected to image forming system 1 is not limited to three image forming apparatuses 100a, 100b, and 100c.

Smart speaker (which is also called an AI speaker) 400 is an interactive and voice-activated speaker. Smart speaker 400 makes transition to a command acceptance mode by receiving a specific command issued before a user gives a speech operation instruction. Smart speaker 400 identifies a speaker from which accepted speech has originated. Smart speaker 400 accepts an instruction from a user for a job accumulated in image forming apparatus 100 and transmits the instruction to server 500. Smart speaker 400 converts a question generated by server 500 into speech and outputs the speech to the user.

When server 500 receives an instruction from a user through smart speaker 400, for identifying a job corresponding to the instruction, the server generates a question based on a feature of each of candidates for the job corresponding to the instruction from the user and transmits the question to smart speaker 400. When server 500 receives an answer from the user to the question through smart speaker 400, the server identifies the job corresponding to the instruction from the user and gives a notification of the instruction from the user to the image forming apparatus (for example, image forming apparatus 100a, 100b, or 100c) which has accumulated the job.

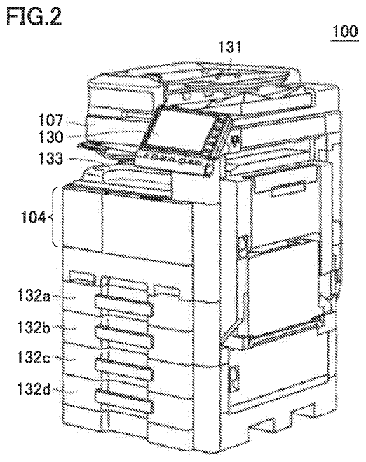

FIG. 2 is a perspective view of image forming apparatus 100 according to the embodiment. Image forming apparatus 100 may be implemented in any form such as a multi-functional peripheral (MFP), a copying machine, a production printer (a commercial printer adapted to a short delivery time, a variety of products, and smaller lots), a facsimile machine, and a printer. Image forming apparatus 100 shown in FIG. 2 performs a plurality of functions such as a scanner function, a copy function, a print function, a facsimile function, a network function, and a BOX function.

Image forming apparatus 100 includes an imaging unit 107 that optically scans a document to obtain image data and a printer engine 104 that prints an image on paper based on image data. In an upper portion of a main body of image forming apparatus 100, a feeder 131 for feeding a document to imaging unit 107 is provided, and in a lower portion of the main body of image forming apparatus 100, a plurality of paper feeders 132a, 132b, 132c, and 132d for supplying paper to printer engine 104 are provided. In a central portion of the main body of image forming apparatus 100, a tray 133 where paper having an image formed by printer engine 104 is ejected is provided. The number of paper feeders 132a, 132b, 132c, and 132d is not limited to four. Paper may be ejected from a finisher provided laterally to the main body of image forming apparatus 100, instead of tray 133.

An operation panel 130 with a display surface is provided on a front surface (a surface to which a user is opposed when the user performs an operation) of the main body of image forming apparatus 100. Operation panel 130 is implemented by a touch panel for operating image forming apparatus 100. Operation panel 130 can show various types of information and accept an input operation by a user. In consideration of operability while the user is standing, operation panel 130 is attached as being inclined obliquely as shown in FIG. 2.

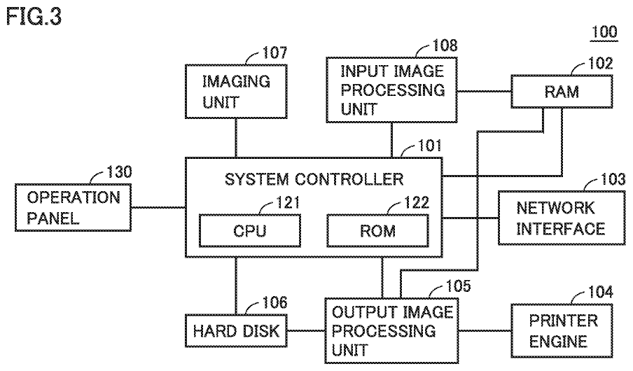

FIG. 3 is a block diagram showing a hardware configuration of image forming apparatus 100. Image forming apparatus 100 includes a system controller 101, a random access memory (RAM) 102, a network interface 103, printer engine 104, an output image processing unit 105, a hard disk 106, imaging unit 107, an input image processing unit 108, and operation panel 130.

System controller 101 is connected to RAM 102, network interface 103, printer engine 104, output image processing unit 105, hard disk 106, imaging unit 107, input image processing unit 108, and operation panel 130 through a bus. System controller 101 is responsible for overall control of operations by each component of image forming apparatus 100 and executes various jobs such as a scanning job, a copy job, a mail transmission job, and a print job. System controller 101 is implemented by a central processing unit (CPU) 121, a read only memory (ROM) 122, and the like. CPU 121 executes a control program stored in ROM 122. ROM 122 stores a control program that controls operations of image forming apparatus 100.

RAM 102 temporarily stores data necessary for CPU 121 to execute a control program.

Network interface 103 communicates with external equipment connected through network 99 (for example, server 500, a PC, and other image forming apparatuses connected through network 99) in accordance with an instruction from system controller 101.

Printer engine 104 prints an image onto paper based on print data processed by output image processing unit 105. When image forming apparatus 100 serves as a printer, printer engine 104 prints an image obtained through network interface 103. When image forming apparatus 100 serves as a copying machine, printer engine 104 prints an image scanned by imaging unit 107.

Output image processing unit 105 creates print data from image data. Hard disk 106 stores various types of data involved with operations of image forming apparatus 100 (for example, image data obtained through network interface 103, image data scanned by imaging unit 107, or image data shown on operation panel 130).

Imaging unit 107 scans a document as an image. Input image processing unit 108 processes data of an image scanned by imaging unit 107.

Image forming apparatus 100 may include hardware other than the hardware described above and may include a known facsimile.

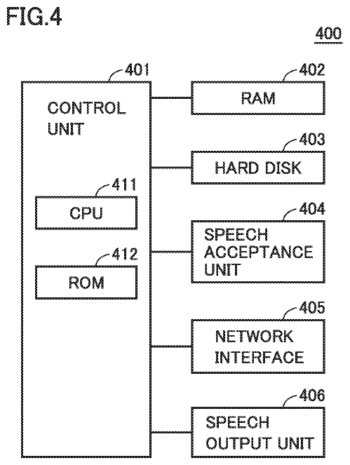

FIG. 4 is a block diagram showing a hardware configuration of smart speaker 400. Smart speaker 400 includes a control unit 401, a RAM 402, a hard disk 403, a speech acceptance unit 404, a network interface 405, and a speech output unit 406.

Control unit 401 is connected to RAM 402, hard disk 403, speech acceptance unit 404, network interface 405, and speech output unit 406 through a bus. Control unit 401 is responsible for overall control of operations by each component of smart speaker 400. Control unit 401 is implemented by CPU 411, ROM 412, and the like. CPU 411 executes a control program stored in ROM 412. ROM 412 stores a control program that controls operations of smart speaker 400.

RAM 402 temporarily stores data necessary for CPU 411 to execute a control program.

Hard disk 403 stores speech (voiceprint) of a user.

Speech acceptance unit 404 is implemented by a microphone and accepts speech of a user. Speech accepted by speech acceptance unit 404 is compared with speech (voiceprint) of the user stored in hard disk 403 and a speaker is identified.

Network interface 405 communicates with server 500 through network 99 in accordance with an instruction from control unit 401. When smart speaker 400 receives an instruction from a user for a job accumulated in image forming apparatus 100, it transmits the instruction from the user accepted together with information on the identified speaker to server 500 through network interface 405. Smart speaker 400 receives from server 500, a question generated by server 500 through network interface 405. When smart speaker 400 receives an answer from the user to the question generated by server 500, it transmits the answer from the user to server 500 through network interface 405.

Speech output unit 406 converts the question received from server 500 into speech and outputs the speech to the user.

Smart speaker 400 may include hardware other than the hardware described above.

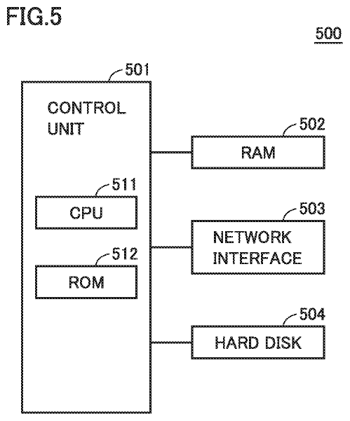

FIG. 5 is a block diagram showing a hardware configuration of server 500. Server 500 includes a control unit 501, a RAM 502, a network interface 503, and a hard disk 504.

Control unit 501 is connected to RAM 502, network interface 503, and hard disk 504 through a bus. Control unit 501 is responsible for overall control of operations by each component of server 500. Control unit 501 is implemented by CPU 511, ROM 512, and the like. CPU 511 executes a control program stored in ROM 512. ROM 512 stores a control program that controls operations of server 500.

RAM 502 temporarily stores data necessary for CPU 511 to execute a control program.

Network interface 503 communicates with smart speaker 400 or image forming apparatus 100 through network 99 in accordance with an instruction from control unit 501. Server 500 receives an instruction from a user or an answer from the user to the question from smart speaker 400 through network interface 503. Server 500 obtains information on a job accumulated in image forming apparatus 100 through network interface 503. Server 500 transmits the generated question to smart speaker 400 through network interface 503. Server 500 transmits an instruction from a user to an image forming apparatus (for example, image forming apparatus 100a, 100b, or 100c) which has accumulated a job corresponding to the instruction from the user.

Hard disk 504 stores various types of data involved with operations of server 500. Specifically, hard disk 504 stores information obtained from image forming apparatus 100 about a job accumulated in image forming apparatus 100, for each of image forming apparatuses 100a, 100b, and 100c.

Information on a job accumulated in each of image forming apparatuses 100a, 100b, and 100c (see FIG. 1) may be stored in a storage different from hard disk 504 of server 500. For example, a storage different from server 500 is connected to server 500 and each of image forming apparatuses 100a, 100b, and 100c through the Internet. Each of image forming apparatuses 100a, 100b, and 100c provides information on a job to the storage. The storage stores the information on the job for each of image forming apparatuses 100a, 100b, and 100c. Server 500 accesses the storage as necessary and obtains information on the job accumulated in each of image forming apparatuses 100a, 100b, and 100c.

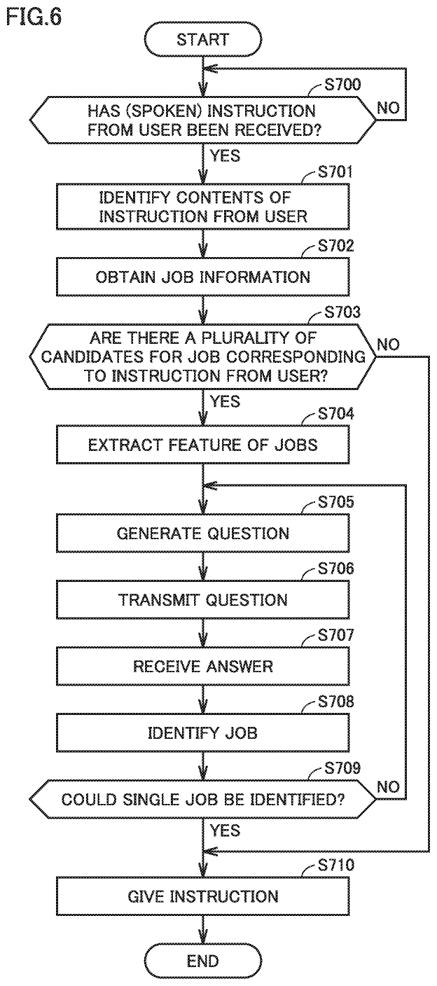

FIG. 6 is a flowchart showing processing by server 500. A series of processing shown in FIG. 6 is processing for identifying, when server 500 receives a (spoken) instruction from a user through smart speaker 400, a job corresponding to the instruction from the user and giving a notification of the instruction to image forming apparatus 100 in which the identified job is accumulated, and is performed by control unit 501.

Initially, control unit 501 determines whether or not it has received a (spoken) instruction from a user through smart speaker 400 (step S700). When control unit 501 has received the (spoken) instruction from the user through smart speaker 400 (YES in step S700), control unit 501 makes transition to step S701. When control unit 501 has not received the (spoken) instruction from the user through smart speaker 400 (NO in step S700), control unit 501 repeats determination processing in step S700 until it receives a (spoken) instruction from the user through smart speaker 400.

In step S701, control unit 501 performs voice recognition processing onto the instruction from the user received through smart speaker 400 and identifies contents of the instruction from the user (for example, “stop job” or “preferentially execute job”).

In step S702, control unit 501 obtains information from image forming apparatus 100 for each of candidates for the job corresponding to the instruction from the user. Examples of the information obtained by control unit 501 include a type of a job, a color selection mode of a document to be processed in a job, the number of pages of a document to be processed in a job, a format of a file to be processed in a job, a name of a file to be processed in a job, the number of images in a document to be processed in a job, contents of an image in a document to be processed in a job, and information representing whether or not a job is currently running (which is also referred to as a “status” below). Control unit 501 has the obtained information stored in hard disk 504. Information obtained by control unit 501 may include information other than the above (for example, time and date of creation of a job and information representing a position of installation of image forming apparatus 100). The information representing a position of installation of image forming apparatus 100 may be a distance between smart speaker 400 and image forming apparatus 100 or a name of an installation location of image forming apparatus 100 such as a copy room 1, vicinity of an entrance, or vicinity of a meeting room. The information representing a position of installation of image forming apparatus 100 is set by a serviceperson at the time when image forming apparatus 100 is installed.

Then, control unit 501 determines whether or not there are a plurality of candidates for a job corresponding to the instruction from the user based on the information obtained in step S702 (step S703). Specifically, when the information obtained in step S702 includes information on a plurality of jobs, control unit 501 determines that there are a plurality of candidates for the job corresponding to the instruction from the user. When there are a plurality of candidates for the job corresponding to the instruction from the user (YES in step S703), control unit 501 makes transition to step S704. When there are not a plurality of candidates for the job corresponding to the instruction from the user, that is, when there is a single candidate for the job corresponding to the instruction from the user (NO in step S703), control unit 501 makes transition to step S710.

In step S704, control unit 501 extracts a feature of each of the jobs (which is also simply referred to as “each of the jobs” below) for the candidates for the job corresponding to the instruction from the user, based on the information on the job obtained in step S702. Examples of the feature of each of the jobs include a type of each of the jobs, a color selection mode of a document to be processed in each of the jobs, the number of pages of a document to be processed in each of the jobs, a format of a file to be processed in each of the jobs, a name of a file to be processed in each of the jobs, the number of images in a document to be processed in each of the jobs, contents of an image in a document to be processed in each of the jobs, and a status of each of the jobs. The feature of each of the jobs extracted by control unit 501 may include a feature other than the above and may include a distance between smart speaker 400 and image forming apparatus 100.

Then, control unit 501 generates a question for identifying the job corresponding to the instruction from the user from among the jobs based on a difference in extracted feature (step S705). Specifically, when the type of the job among the extracted features is different, control unit 501 generates a question “what is the type of the job?” When the color selection mode of the document among the extracted features is different, control unit 501 generates a question “what is the color selection mode of the document?”

Then, control unit 501 transmits the generated question to smart speaker 400 (step S706). The question transmitted to smart speaker 400 is output as speech from speech output unit 406. The user can give an answer by speech to the question output as speech. The answer from the user is accepted by speech acceptance unit 404 and transmitted to server 500.

Then, control unit 501 receives the answer from the user through smart speaker 400 (step S707). Then, control unit 501 identifies the job corresponding to the instruction from the user based on the received answer (step S708). Then, control unit 501 determines whether or not a single job could be identified as the job corresponding to the instruction from the user (step S709). When a single job could be identified as the job corresponding to the instruction from the user (YES in step S709), control unit 501 makes transition to step S710. When a single job could not be identified as the job corresponding to the instruction from the user (NO in step S709), control unit 501 makes transition to step S705. For example, when an answer “print” to the question “what is the type of the job?” is obtained and only a single print job is included in the jobs, control unit 501 can identify that single job as the job corresponding to the instruction from the user. When a plurality of print jobs are included in the jobs, however, control unit 501 is unable to identify a single job as the job corresponding to the instruction from the user. When control unit 501 is unable to identify a single job as the job corresponding to the instruction from the user (NO in step S709), the process makes transition to processing (step S705) for generating a question based on a difference in feature, for the job identified in step S708.

In step S710, control unit 501 gives a notification of the instruction from the user to image forming apparatus 100 which has accumulated the identified single job corresponding to the instruction from the user. The instruction from the user is thus performed by image forming apparatus 100 which has received the notification.

Control unit 501 quits the series of processing shown in FIG. 6 after the processing in step S710.

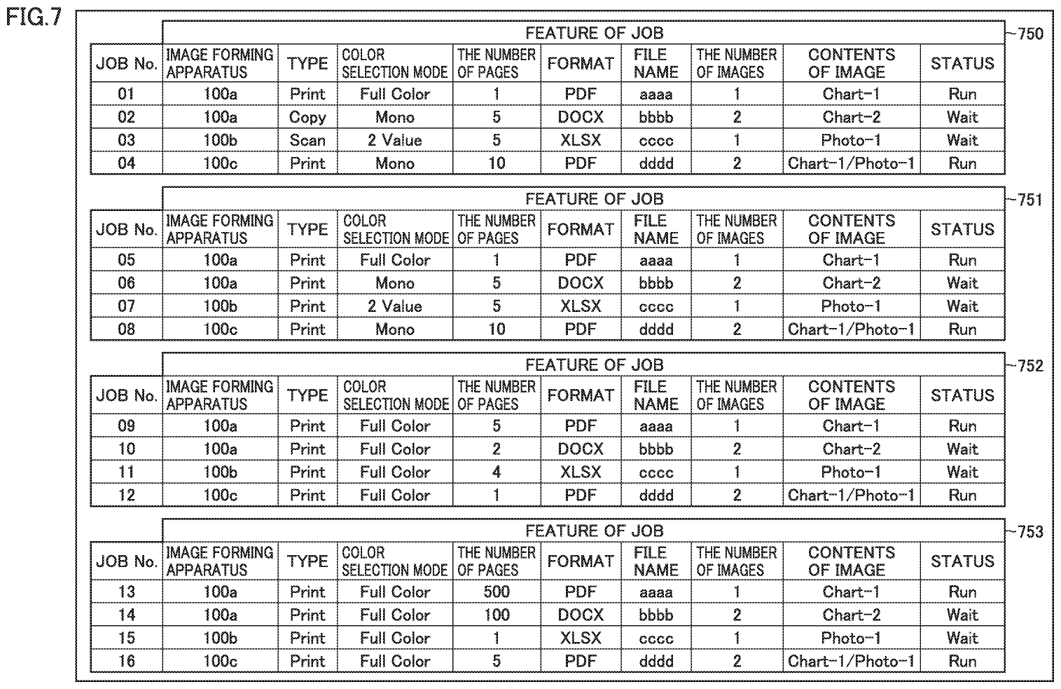

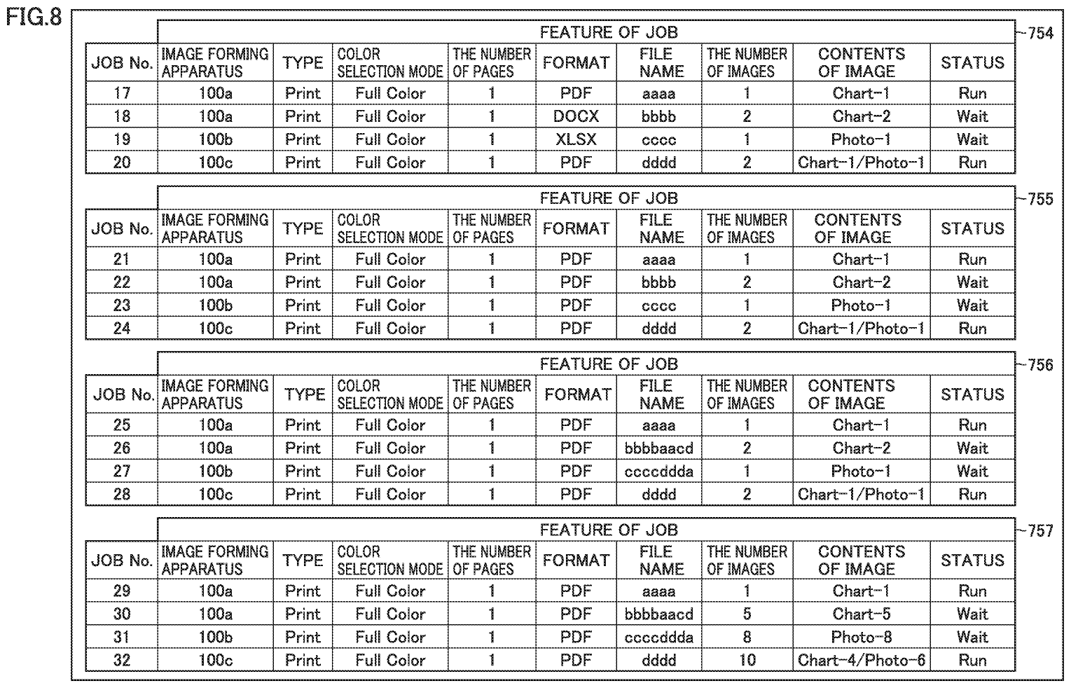

FIG. 7 shows tables 750 to 753 summarizing features of each of candidates for a job corresponding to an instruction from a user. FIG. 8 shows tables 754 to 757 summarizing features of each of candidates for a job corresponding to an instruction from a user. Tables 750 to 757 include job Nos. and features of jobs. Job No, is an identification number of a job and provided by control unit 501 when server 500 obtains information on a job accumulated in image forming apparatus 100 from image forming apparatus 100. Features of jobs (“image forming apparatus,” “type”, “color selection mode,” “the number of pages,” “format”, “file name,” “the number of images,” “contents of image,” and “status”) are extracted (step S704) based on information obtained by control unit 501 from image forming apparatus 100 (step S702). Tables 750 to 757 are stored in hard disk 504. Tables 750 to 757 are updated each time server 500 obtains information on a job from image forming apparatus 100 (step S702).

“Image forming apparatus” among the features of the jobs refers to information on which identification of an image forming apparatus where a job is accumulated can be based, and it is expressed, for example, by “100a” for image forming apparatus 100a, by “100b” for image forming apparatus 100b, or “100c” for image forming apparatus 100c.

“Type” among the features of the jobs refers to information on which identification of a type of a job can be based, and it is expressed, for example, by “Copy” for a copy job, by “Print” for a print job, or by “Scan” for a scanning job.

“Color selection mode” among the features of the jobs refers to information on which identification of a color selection mode of a document to be processed in a job can be based, and it is expressed, for example, by “Full Color” for a full color mode, by “Mono” for a monochrome mode, and by “2 value” for a bicolor mode.

“The number of pages” among the features of the jobs refers to information on which identification of the number of pages of a document to be processed in a job can be based, and it is expressed, for example, by a numeric value such as “5” in an example where a document to be processed in a job contains five pages.

“Format” among the features of the jobs refers to information on which identification of a format of a file to be processed in a job can be based, and it is expressed, for example, by “PDF”, “DOCX”, or “XLSX”.

“File name” among the features of the jobs refers to information on which identification of a name of a file to be processed in a job can be based, and it is expressed, for example, by “aaaa”, “bbbb”, “cccc”, or “dddd”.

“The number of images” among the features of the jobs refers to information on which identification of the number of images in a document to be processed in a job can be based, and it is expressed by a numeric value such as “2” in an example where there are two images in a document to be processed in a job.

“Contents of image” among the features of the jobs refers to information on which identification of a type and the number of images in a document to be processed in a job can be based, and it is expressed, for example, by “Chart-1” in an example where an image in a document to be processed in a job consists of one graph, by “Photo-1” in an example where an image in a document to be processed in a job consists of one photograph, and by “Chart-1/Photo-1” in an example where an image in a document to be processed in a job consists of one graph and one photograph.

“Status” among the features of the jobs refers to information on which determination as to whether or not a job is running can be based, and it is expressed, for example, by “Run” when a job is running and by “Wait” when a job stands by.

For example, referring to table 750, a job 01 is accumulated in image forming apparatus 100a, the type of the job is a print job, the color selection mode of a document to be processed in the job is full color, the number of pages of the document to be processed in the job is one, the format of the file to be processed in the job is PDF, the name of the file to be processed in the job is aaaa, the number of images in the document to be processed in the job is one, the image in the document to be processed in the job is a graph, and the status of the job is run.

When there is a difference in “type” of the job among the extracted features of the job, control unit 501 generates a question asking about the type of the job. For example, it is assumed that the feature of the job extracted by control unit 501 is shown in table 750. The “type” of the job is varied as shown as “Print”, “Copy”, and “Scan”. In such a case, control unit 501 generates a question “what is the type of the job?”

When the “type” of the job among the extracted features of the job is not different but the “color selection mode” of the document is different, control unit 501 generates a question asking about the color selection mode of the document. For example, it is assumed that the feature of the job extracted by control unit 501 is shown in table 751. The “type” of the job is “Print” in all jobs, and hence the “type” of the job is not different. The “color selection mode” of the document, however, is varied as shown as “Full Color,” “Mono”, and “2 value.” In such a case, control unit 501 generates a question “what is the color selection mode of the document?”

When the “type” of the job” and the “color selection mode” of the document among the extracted features of the job are not different but “the number of pages” of the document is different and when a difference in number of pages of the document is smaller than a threshold value in all jobs, control unit 501 generates a question asking about the number of pages of the document. For example, it is assumed that the feature of the job extracted by control unit 501 is shown in table 752. The “type” of the job is “Print” in all jobs and the “color selection mode” of the document is “Full Color” in all jobs, and hence the “type” of the job and the “color selection mode” of the document are not different. “The number of pages” of the document is varied as shown as “5”, “2”, “4”, and “1”, and the difference in number of pages of the document is smaller than a threshold value (for example, “50”) in all jobs. In such a case, control unit 501 generates a question “how many pages are contained in the document?” The threshold value of the difference in number of pages of a document is not limited to “50”.

When the “type” of the job and the “color selection mode” of the document among the extracted features of the job are not different but “the number of pages” of the document is different and when there is a job in which the difference in number of pages of the document is equal to or greater than a threshold value, control unit 501 generates a question asking about whether the number of pages of the document is large or small. For example, it is assumed that the feature of the jobs extracted by control unit 501 is shown in table 753. The “type” of the job is “Print” in all jobs and the “color selection mode” of the document is “Full Color” in all jobs, and hence the type of the job and the “color selection mode” of the document are not different. On the other hand, the “number of pages” of the document is different as shown as “500”, “100”, “1”, or “5” and there is a job in which the difference in number of pages of the document is equal to or greater than the threshold value (for example, “50”). In such a case, control unit 501 generates a question “is the number of pages of the document large or small?” The threshold value of the difference in number of pages of the document is not limited to “50”.

When the “type” of the job and the “color selection mode” and “the number of pages” of the document among the extracted features of the jobs are not different but the “format” of the file is different, control unit 501 generates a question asking about the format of the file. For example, it is assumed that the feature of the jobs extracted by control unit 501 is shown in table 754. The “type” of the job is “Print” in all jobs, the “color selection mode” of the document is “Full Color” in all jobs, and the “number of pages” of the document is “1” in all jobs, and hence the “type” of the job and the “color selection mode” and “the number of pages” of the document are not different. On the other hand, the “format” of the file is different as shown as “PDF”, “DOCX”, or “XLSX”. In such a case, control unit 501 generates a question “what is the format of the file?”

When the “type” of the job, the “color selection mode” and “the number of pages” of the document, and the “format” of the file among the extracted features of the jobs are not different but a length of the “file name” is smaller than a threshold value in all jobs, control unit 501 generates a question asking about the name of the file. For example, it is assumed that the feature of the jobs extracted by control unit 501 is shown in table 755. The “type” of the job is “Print” in all jobs, the “color selection mode” of the document is “Full Color” in all jobs, “the number of pages” of the document is “I” in all jobs, and the “format” of the file is “PDF” in all jobs, and hence the “type” of the job, the “color selection mode” and “the number of pages” of the document, and the “format” of the file are not different. The length of the “file name” is smaller than the threshold value (for example, “5”) in all jobs. In such a case, control unit 501 generates a question “what is the name of the file?” The threshold value of the length of the “file name” is not limited to “5”.

When the “type” of the job, the “color selection mode” and “the number of pages” of the document, and the “format” of the file among the extracted features of the jobs are not different, when there is a job in which a length of the “file name” is equal to or greater than the threshold value, and when a difference in “number of images” in the document is equal to or smaller than a threshold value in all jobs, control unit 501 generates a question asking about contents of an image in the document. For example, it is assumed that the feature of the jobs extracted by control unit 501 is shown in table 756. The “type” of the job is “Print” in all jobs, the “color selection mode” of the document is “Full Color” in all jobs. “the number of pages” of the document is “I” in all jobs, and the “format” of the file is “PDF” in all jobs, and hence the “type” of the job, the “color selection mode” and “the number of pages” of the document, and the “format” of the file are not different. There is a job in which the length of the “file name” is equal to or greater than the threshold value (for example, “5”) and a difference in “number of images” in the document is equal to or smaller than a threshold value (for example, “1”) in all jobs. In such a case, control unit 501 generates a question “What kind of image is included in the document? Give the type and the number of images.” The threshold value of the length of the “file name” is not limited to “5”. The threshold value of the difference in “number of images” in the document is not limited to “1”.

When the “type” of the job, the “color selection mode” and “the number of pages” of the document, and the “format” of the file among the extracted features of the jobs are not different, when there is a job in which the length of the “file name” is equal to or greater than the threshold value, and when there is a job in which the difference in “number of images” in the document exceeds the threshold value, control unit 501 generates a question asking about the number of images in the document. For example, it is assumed that the feature of the jobs extracted by control unit 501 is shown in table 757. The “type” of the job is “Print” in all jobs, the color selection mode” of the document is “Full Color” in all jobs, “the number of pages” of the document is “1” in all jobs, and the “format” of the file is “PDF” in all jobs, and hence the “type” of the job, the “color selection mode” and “the number of pages” of the document, and the “format” of the file are not different. There is a job in which the length of the “file name” is equal to or greater than the threshold value (for example, “5”) and there is a job in which the difference in “number of images” in the document exceeds the threshold value (for example, “1”). In such a case, control unit 501 generates a question asking about “how many images are contained in the document?” The threshold value of the length of the “file name” is not limited to “5”. The threshold value of the difference in “number of images” in the document is not limited to “1”.

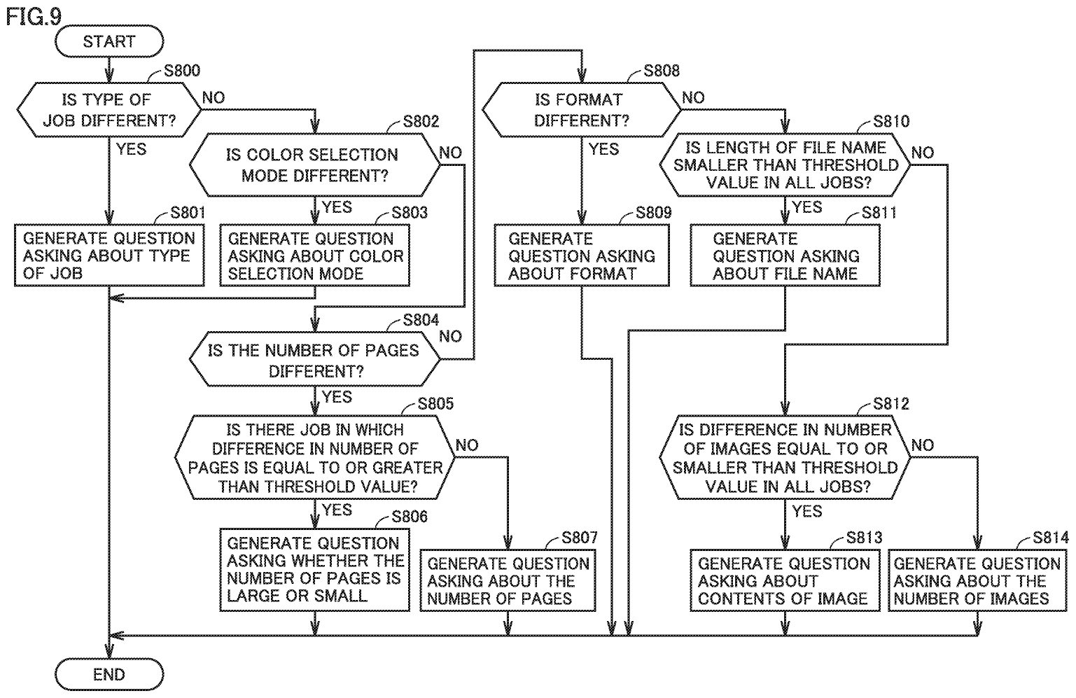

Control unit 501 thus generates a question based on a difference in extracted feature of the jobs. FIG. 9 is a flowchart showing processing for control unit 501 to generate a question (step S705).

Referring to FIG. 9, initially, control unit 501 determines whether or not a type of a job among extracted features of jobs is different (step S800). When the type of the job is different (YES in step S800), control unit 501 generates a question asking about the type of the job (step S801). When the type of the job is not different (NO in step S800), control unit 501 makes transition to step S802.

In step S802, control unit 501 determines whether or not the color selection mode of a document among the extracted features of the jobs is different. When the color selection mode of the document is different (YES in step S802), control unit 501 generates a question asking about the color selection mode of the document (step S803). When there is no difference in color selection node of the document (NO in step S802), control unit 501 makes transition to step S804.

In step S804, control unit 501 determines whether or not the number of pages of the document among the extracted features of the jobs is different. When the number of pages of the document is different (YES in step S804), control unit 501 makes transition to step S805. When the number of pages of the document is not different (NO in step S804), control unit 501 makes transition to step S808.

In step S805, control unit 501 determines whether or not there is a job in which a difference in number of pages of the document is equal to or greater than a threshold value. When there is a job in which the difference in number of pages of the document is equal to or greater than the threshold value (YES in step S805), control unit 501 generates a question asking about whether the number of pages of the document is large or small (step S806). When the difference in number of pages of the document is smaller than the threshold value in all jobs (NO in step S805), control unit 501 generates a question asking about the number of pages of the document (step S807).

In step S808, control unit 501 determines whether or not a format of a file among the extracted features of the jobs is different. When the format of the file is different (YES in step S808), control unit 501 generates a question asking about the format of the file (step S809). When the format of the file is not different (NO in step S808), control unit 501 makes transition to step S810.

In step S810, control unit 501 determines whether or not a length of a file name of the document is smaller than the threshold value in all jobs. When the length of the file name is smaller than the threshold value in all jobs (YES in step S810), control unit 501 generates a question asking about the file name (step S811). When there is a job in which the length of the file name exceeds the threshold value (NO in step S810), control unit 501 makes transition to step S812.

In step S812, control unit 501 determines whether or not the difference in number of images in the document is equal to or smaller than the threshold value in all jobs. When the difference in number of images in the document is equal to or smaller than the threshold value in all jobs (YES in step S812), control unit 501 generates a question asking about contents of an image in the document (step S813). When there is a job in which the difference in number of images in the document exceeds the threshold value (NO in step S812), control unit 501 generates a question asking about the number of images in the document (step S814).

After the processing in step S801, S803, S806, S807, S809, S811, S813, or S814, control unit 501 quits the series of processing shown in FIG. 9.

Though control unit 501 generates a question in FIG. 9 based on a difference in feature of all jobs extracted in step S704 regardless of whether or not jobs are running, control unit 501 may preferentially generate a question based on a difference in feature of jobs that are running.

When candidates for a job corresponding to an instruction from a user are accumulated in a plurality of image forming apparatuses, control unit 501 may generate a question asking about a position of installation of image forming apparatus 100 in which the job corresponding to the instruction is accumulated. A question asking about the position of installation of image forming apparatus 100 in which the job corresponding to the instruction is accumulated is generated after the user were asked questions a specific number of times. Specifically, when candidates for the job corresponding to the instruction from the user are accumulated in a plurality of image forming apparatuses and the user were asked questions a specific number of times, control unit 501 generates a question “around where image forming apparatus 100 where the job corresponding to the instruction has been accumulated is installed?” The question asking about the position of installation of image forming apparatus 100 where the job corresponding to the instruction has been accumulated is not limited as such, and a question “is image forming apparatus 100 where the job corresponding to the instruction has been accumulated near or far from here?” is also applicable and contents of the question are determined based on information representing the position of installation of image forming apparatus 100 that is obtained from image forming apparatus 100.

The question generated by control unit 501 is not limited to an open-ended question such as “what is the type of the job?” Control unit 501 may generate a multiple-choice question such as “is the type of the job copy, print, or scanning?” When control unit 501 generates a multiple-choice question, choices desirably include extracted features.

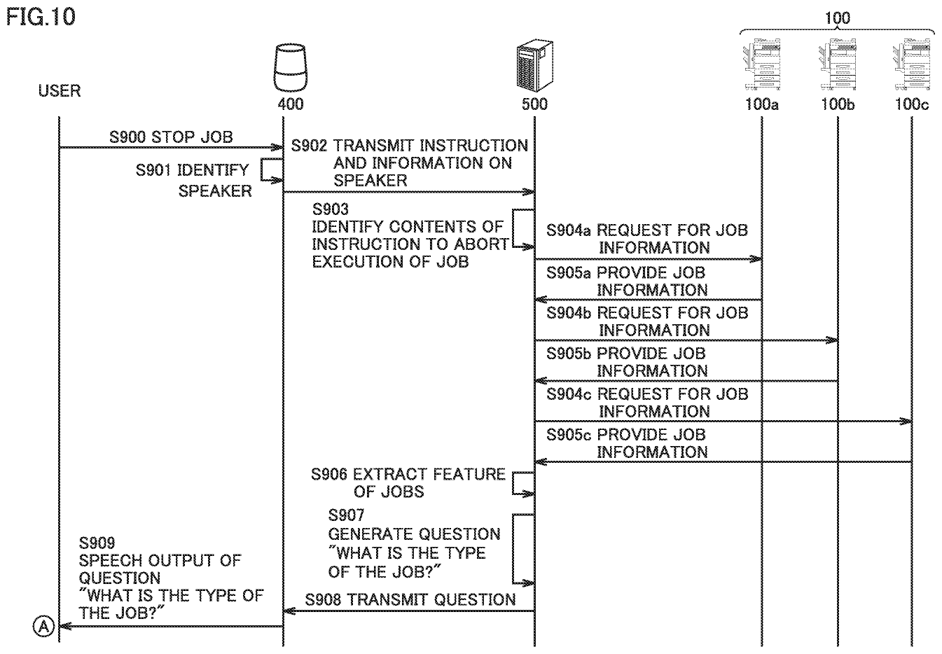

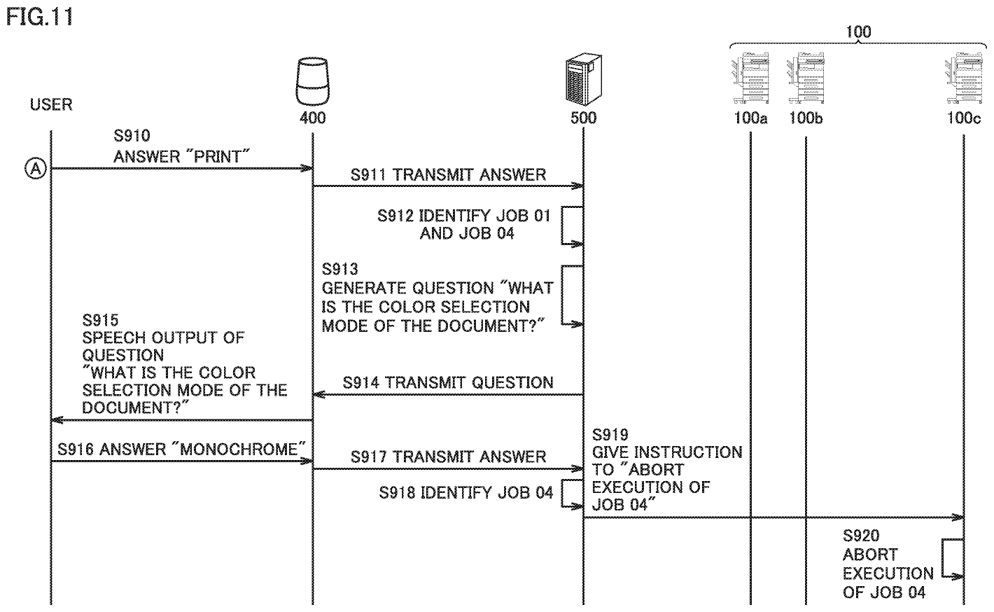

FIGS. 10 and 11 are sequence diagrams showing exemplary processing by image forming system 1. The example shown in FIGS. 10 and 11 assumes that user's jobs accumulated in image forming apparatus 100 are jobs 01 to 04 shown in table 750 and the user desires to stop execution of job 04.

Referring to FIGS. 10 and 11, when the user gives an instruction “stop job” to smart speaker 400 (step S900), smart speaker 400 compares the accepted speech with speech (voiceprint) of the user stored in hard disk 403 and identifies a speaker (step S901). The instruction from the user should only be an instruction for a job accumulated in image forming apparatus 100, and it is not limited to the instruction “stop job.” When the user desires prioritized execution of the job, the user may give an instruction “prioritize execution of the job.” Then, smart speaker 400 transmits the accepted instruction from the user and information on the identified speaker to server 500 (step S902).

When server 500 receives the instruction from the user and the information on the identified speaker through smart speaker 400, the server performs voice recognition processing and identifies contents of the instruction from the user to “abort execution of job” (step S903). Then, server 500 requests image forming apparatus 100 for information on the user's job identified based on the information on the speaker received through smart speaker 400 (steps S904a, S904b, and S904c). In response to the request, image forming apparatus 100 provides information corresponding to the request, that is, information on jobs 01 to 04, to server 500 (steps S905a, S905b, and S905c).

Server 500 extracts a feature of each of the jobs from the information on the job provided by image forming apparatus 100 (step S906). Since the “type” of the job among the extracted feature is varied as shown as “Print”, “Copy”, and “Scan”, server 500 generates a question “what is the type of the job?” (step S907) and transmits the question to smart speaker 400 (step S908).

Smart speaker 400 provides a speech output of the question “what is the type of the job?” (step S909). When the user answers “print” (step S910), smart speaker 400 transmits the answer from the user “print” to server 500 (step S911).

Then, when server 500 receives the answer from the user “print” through smart speaker 400, the server identifies job 01 or job 04 as the job corresponding to the instruction from the user based on the received answer (step S912). Then, since server 500 was unable to identify a single job corresponding to the instruction from the user, server 500 generates a question based on a difference in feature between job 01 and job 04 identified in step S912 (step S913). Specifically, though the “type” of the job is “Print” in each of the jobs, the “color selection mode” of the document is different between “Full Color” and “Mono”. Therefore, server 500 generates a question “what is the color selection mode of the document?” (step S913) and transmits the question to smart speaker 400 (step S914).

Smart speaker 400 provides a speech output of the question “what is the color selection mode of the document?” (step S915). When the user answers “monochrome” (step S916), smart speaker 400 transmits the answer from the user “monochrome” to server 500 (step S917).

Then, when server 500 receives the answer from the user “monochrome” through smart speaker 400, the server identifies job 04 as the job corresponding to the instruction from the user based on the received answer (step S918). Then, since the server was able to identify a single job corresponding to the instruction from the user, server 500 gives a notification of the instruction from the user to “abort execution of job 04” to image forming apparatus 100c in which job 04 identified in step S918 is accumulated (step S919). In image forming apparatus 100c which has received the notification, execution of job 04 is aborted (step S920).

In image forming system 1, a job corresponding to an instruction from a user “stop job” is thus identified and processing corresponding to the instruction from the user, that is, execution of the identified job, is aborted.

As set forth above, in image forming system 1 according to the embodiment, smart speaker 400 accepts a spoken instruction directed to a job accumulated in image forming apparatus 100 and server 500 generates a question based on a difference in feature of each of candidates for the job corresponding to the instruction from the user. Thus, even when there are a plurality of candidates for the job corresponding to the instruction from the user, a question is asked based on the difference in feature of each of the jobs and hence the job corresponding to the instruction from the user is identified in a time period as short as possible. Consequently, when the instruction from the user is an instruction to stop a print job or a copy job, the job corresponding to the instruction from the user is identified in a time period as short as possible and waste of paper or toner can be prevented. When the instruction from the user is prioritized execution of a job, the job corresponding to the instruction from the user is identified in a time period as short as possible and hence a period of stand-by by the user until completion of the job corresponding to the instruction can be minimized.

Server 500 may be implemented by any of image forming apparatuses 100 such as image forming apparatus 100a. When server 500 is implemented by image forming apparatus 100a, image forming apparatus 100a performs the series of processing shown in FIG. 6.

Image forming system 1 according to the embodiment includes smart speaker 400 separately from image forming apparatus 100 and smart speaker 400 accepts speech of a user and provides speech output to the user. The function of smart speaker 400, however, may be contained in image forming apparatus 100.

Though image forming apparatus 100 represents exemplary image forming apparatuses in image forming system 1 according to the embodiment, a single image forming apparatus 100 may be provided.

Though image forming apparatus 100 transmits information on a job to server 500 in image forming system 1 according to the embodiment, the information on the job may be provided to server 500 by transmitting the information to a storage that is different from server 500 and accessible by server 500.

### Modification

Though image forming system 1 according to the embodiment is constituted of smart speaker 400, server 500, and image forming apparatus 100, an image forming system according to a modification consists of an image forming apparatus 200. Image forming apparatus 200 includes the components of smart speaker 400 and the components of server 500 in addition to the components of image forming apparatus 100.

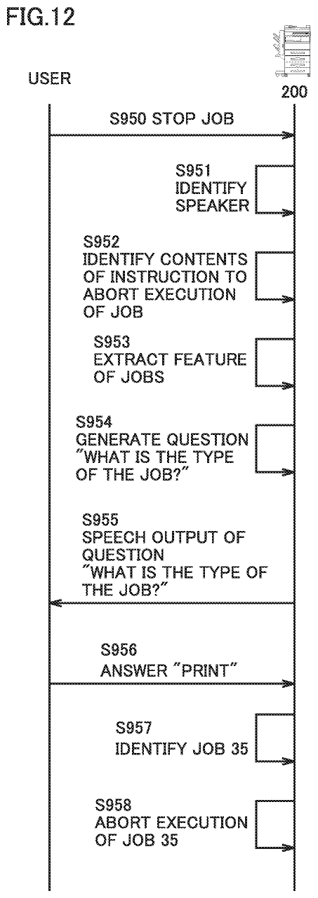

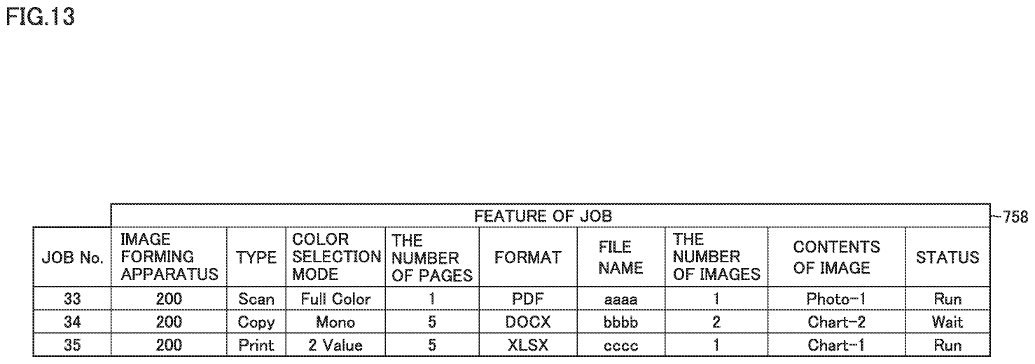

Processing by image forming apparatus 200 in the modification will be described with reference to FIGS. 12 and 13. FIG. 12 is a sequence diagram showing exemplary processing by image forming apparatus 200 in the modification. FIG. 13 shows a table 758 summarizing features of each of candidates for a job corresponding to an instruction from a user. FIG. 12 shows an example where user's jobs accumulated in image forming apparatus 200 are assumed as jobs 33 to 35 in table 758 and the user desires to stop execution of job 35. Since table 758 is similar in structure to tables 750 to 757, description thereof will not be repeated.

Referring to FIG. 12, when the user instructs image forming apparatus 200 to “stop job” (step S950), image forming apparatus 200 compares accepted speech with speech (voiceprint) of the user stored in a storage and identifies a speaker (step S951). Then, image forming apparatus 200 performs voice recognition processing and identifies contents of the instruction from the user to “stop execution of the job” (step S952).

Image forming apparatus 200 extracts a feature of each of candidates for the job corresponding to the instruction from the user (step S953). Since the “type” of the job among the extracted features is varied as shown as “Scan”, “Copy”, and “Print”, image forming apparatus 200 generates a question “what is the type of the job?” (step S954) and provides a speech output thereof (step S955).

When the user answers “print” in response (step S956), image forming apparatus 200 identifies job 35 as the job corresponding to the instruction from the user based on the received answer (step S957). Then, image forming apparatus 200 aborts execution of identified job 35 (step S958).

Image forming apparatus 200 thus accepts an instruction from a user to “stop job”, identifies the job corresponding to the instruction, and performs processing corresponding to the instruction, that is, abortion of execution of the identified job.

As set forth above, in the image forming system according to the modification, image forming apparatus 200 accepts a spoken instruction directed to an accumulated job and asks a question based on a difference in feature of each of candidates for the job corresponding to the instruction from the user. Thus, even though there are a plurality of candidates for the job corresponding to the instruction from a user, a question based on a difference in feature of each of the jobs is asked and hence the job corresponding to the instruction from the user is identified in a time period as short as possible. Consequently, when the instruction from the user is an instruction to stop a print job or a copy job, the job corresponding to the instruction from the user is identified in a time period as short as possible and waste of paper or toner can be prevented. When the instruction from the user is prioritized execution of a job, the job corresponding to the instruction from the user is identified in a time period as short as possible and hence a period of stand-by by the user until completion of the job corresponding to the instruction can be minimized.

Although embodiments of the present invention have been described and illustrated in detail the disclosed embodiments are made for the purposes of illustration and example only and not limitation. The scope of the present invention should be interpreted by terms of the appended claims.

What is claimed is:

1. An image forming system comprising:
a control device that communicates with an interactive electronic device that accepts a spoken instruction; and
a plurality of image forming apparatuses that communicate with the control device,
each of the plurality of image forming apparatuses including
a first processor, and
a first memory that accumulates a job,
the control device including a second processor,
the second processor
obtaining information on jobs accumulated in the plurality of image forming apparatuses,
receiving, when the interactive electronic device accepts an instruction from a user for a job accumulated in any of the plurality of image forming apparatuses, the instruction from the interactive electronic device,
extracting, when there are a plurality of candidates for the job corresponding to the received instruction from the user, a feature of each of the plurality of candidates for the job based on the obtained information on the jobs,
generating a question for identifying the job corresponding to the instruction from among the plurality of candidates for the job based on a difference in extracted feature, and
transmitting the generated question to the interactive electronic device.

2. The image forming system according to claim 1, wherein
the control device further includes a second memory that stores the obtained information on the jobs, and
the second processor determines whether there are a plurality of candidates for the job corresponding to the received instruction from the user based on the information in the second memory.

3. The image forming system according to claim 1, wherein
the second processor
receives an answer from the user to the question output from the interactive electronic device,
identifies the job corresponding to the instruction based on the received answer, and
gives a notification of the instruction to an image forming apparatus which has accumulated the identified job, and
the first processor performs processing corresponding to the instruction onto the job accumulated in the first memory, based on the notification received from the control device.

4. The image forming system according to claim 1, wherein
the control device is implemented by an image forming apparatus.

5. The image forming system according to claim 1, wherein
extracting a feature of each of the plurality of candidates for the job based on the obtained information on the jobs includes extracting a type of each of the jobs.

6. The image forming system according to claim 1, wherein
extracting a feature of each of the plurality of candidates for the job based on the obtained information on the jobs includes extracting any of a color selection mode of a document to be processed in each of the jobs, the number of pages of a document to be processed in each of the jobs, a format of a file to be processed in each of the jobs, a name of a file to be processed in each of the jobs, the number of images in a document to be processed in each of the jobs, and contents of an image in a document to be processed in each of the jobs.

7. The image forming system according to claim 1, wherein
extracting a feature of each of the plurality of candidates for the job based on the obtained information on the jobs includes extracting information as to whether each of the jobs is currently running.

8. The image forming system according to claim 1, wherein
extracting a feature of each of the plurality of candidates for the job based on the obtained information on the jobs includes extracting information representing a position of installation of an image forming apparatus that has accumulated each of the jobs.

9. The image forming system according to claim 1, wherein
generating a question for identifying the job corresponding to the instruction from among the plurality of candidates for the job based on a difference in extracted feature includes preferentially generating a question based on a difference in feature of a job that is running.

10. The image forming system according to claim 1, wherein
generating a question for identifying the job corresponding to the instruction from among the plurality of candidates for the job based on a difference in extracted feature includes generating, when a type of each of the jobs is different, a question asking about the type of the job.

11. The image forming system according to claim 1, wherein
generating a question for identifying the job corresponding to the instruction from among the plurality of candidates for the job based on a difference in extracted feature includes generating, when a type of each of the jobs is identical and a color selection mode of a document to be processed in each of the jobs is different, a question asking about the color selection mode of the document.

12. The image forming system according to claim 1, wherein
generating a question for identifying the job corresponding to the instruction from among the plurality of candidates for the job based on a difference in extracted feature includes generating, when a type of each of the jobs is identical, a color selection mode of a document to be processed in each of the jobs is identical, and the number of pages of a document to be processed in each of the jobs is different, a question asking about the number of pages of the document.

13. The image forming system according to claim 1, wherein
generating a question for identifying the job corresponding to the instruction from among the plurality of candidates for the job based on a difference in extracted feature includes generating, when a type of each of the jobs is identical, a color selection mode of a document to be processed in each of the jobs is identical, the number of pages of a document to be processed in each of the jobs is different, and there is a job in which a difference in number of pages of the document to be processed in each of the jobs is equal to or greater than a threshold value, a question asking about whether the number of pages of the document is large or small.

14. The image forming system according to claim 1, wherein
generating a question for identifying the job corresponding to the instruction from among the plurality of candidates for the job based on a difference in extracted feature includes generating, when a type of each of the jobs is identical, a color selection mode and the number of pages of a document to be processed in each of the jobs are identical, and a format of a file to be processed in each of the jobs is different, a question asking about the format of the file.

15. The image forming system according to claim 1, wherein
generating a question for identifying the job corresponding to the instruction from among the plurality of candidates for the job based on a difference in extracted feature includes generating, when a type of each of the jobs is identical and a color selection mode and the number of pages of a document to be processed in each of the jobs and a format of a file to be processed in each of the jobs are identical, a question asking about a name of the file.

16. The image forming system according to claim 1, wherein
generating a question for identifying the job corresponding to the instruction from among the plurality of candidates for the job based on a difference in extracted feature includes generating, when a type of each of the jobs is identical, a color selection mode and the number of pages of a document to be processed in each of the jobs and a format of a file to be processed in each of the jobs are identical, and there is a job in which a name of a file to be processed in each of the jobs is equal to or longer than a threshold value, a question asking about the number of images in a document.

17. The image forming system according to claim 1, wherein
generating a question for identifying the job corresponding to the instruction from among the plurality of candidates for the job based on a difference in extracted feature includes generating, when a type of each of the jobs is identical, a color selection mode and the number of pages of a document to be processed in each of the jobs and a format of a file to be processed in each of the jobs are identical, there is a job in which a name of a file to be processed in each of the jobs is equal to or longer than a threshold value, and a difference in number of images in a document to be processed in each of the jobs is equal to or smaller than a threshold value in all jobs, a question asking about contents of an image in a document.

18. The image forming system according to claim 1, wherein
generating a question for identifying the job corresponding to the instruction from among the plurality of candidates for the job based on a difference in extracted feature includes generating, when the candidates for the job are accumulated in a plurality of image forming apparatuses, a question asking about a position of installation of an image forming apparatus.

19. The image forming system according to claim 1, wherein
generating a question for identifying the job corresponding to the instruction from among the plurality of candidates for the job based on a difference in extracted feature includes generating a multiple-choice question.

20. A control device comprising:
an interface that communicates with an interactive electronic device that accepts a spoken instruction and with a plurality of image forming apparatuses; and
a processor,
the processor
obtaining information on jobs accumulated in the plurality of image forming apparatuses,
receiving, when the interactive electronic device accepts an instruction from a user for a job accumulated in any of the plurality of image forming apparatuses, the instruction from the interactive electronic device,
extracting, when there are a plurality of candidates for the job corresponding to the received instruction from the user, a feature of each of the plurality of candidates for the job based on the obtained information on the jobs,
generating a question for identifying the job corresponding to the instruction from among the plurality of candidates for the job based on a difference in extracted feature, and
transmitting the generated question to the interactive electronic device.

21. An image forming apparatus comprising:
a first processor,
a first memory that accumulates a job; and
an interface that communicates with a control device that communicates with an interactive electronic device that accepts a spoken instruction,
the control device including a second processor,
the second processor
obtaining information on jobs accumulated in a plurality of image forming apparatuses,
receiving from the interactive electronic device, an instruction from a user for a job accumulated in any of the plurality of image forming apparatuses,
generating, when there are a plurality of candidates for the job corresponding to the instruction, a question for identifying the job corresponding to the instruction based on a difference in feature extracted from each of the plurality of candidates for the job based on the obtained information on the jobs, and
transmitting the question to the interactive electronic device,
the first processor transmitting to the control device, the information on the job accumulated in the first memory for the control device to extract the feature.

22. An image forming apparatus comprising:
a first processor, and
a first memory that accumulates a job,
the first processor
accepting a spoken instruction from a user for the job accumulated in the first memory,
extracting, when a plurality of candidates for the job corresponding to the instruction are accumulated, a feature of each of the plurality of candidates for the job,
generating a question for identifying the job corresponding to the instruction from among the plurality of candidates for the job based on a difference in extracted feature,
outputting the generated question,
identifying the job corresponding to the instruction based on an answer from the user to the question, and
performing processing corresponding to the instruction onto the identified job.
